(19) United States
(12) Patent Application Publication
(10) Pub. No.: US 2005/0036301 A1
(43) Pub. Date: Feb. 17, 2005

(54) Illuminated beverage container

(76) Inventor: Troy Haines, Arlington Heights, IL (US)

Correspondence Address: Law Offices of John D. Gugliotta PE, Esq., 202 Delaware Building, 137 South Main Street, Akron, OH, 44308, US

(21) Appl. No.: 10/900,800

(22) Filed: Jul. 28, 2004

Related U.S. Application Data
(60) Provisional application No. 60/490,485, filed on Jul. 28, 2003.

(51) Int. Cl. F21V 33/00

(52) U.S. Cl. 362/101

(57) ABSTRACT

An illuminated beverage container is provided that includes a top portion, a base portion and a body portion therebetween, the top, base and body portions combining to form a storage volume for holding desired liquid beverages. The base portion includes a rotatable dial for engaging and disengaging illumination means, wherein illumination means provides illumination through the beverage contained therein, through the beverage container, and/or through a lens provided in the base portion.

### RELATED APPLICATIONS

The present invention claims the benefit of U.S. Provisional Patent 60/490,485, filed on Jul. 28, 2003, and in incorporated by reference herein.

### BACKGROUND OF THE INVENTION

1. Field of the Invention

The present invention relates generally to beverage containers, and more particularly, to beverage containers having illumination means housed within the beverage container.

2. Description of the Related Art

Camping, hunting, fishing and other outdoor activities are enjoyed by many. A common item that is used during all of these activities, especially night time activities, is a battery powered light, such as a flashlight or lantern. Another common item is a disposable plastic container for holding water or other liquid that serves as a refreshing beverage. Such disposable plastic containers are commonly sold at grocery stores in a variety of sizes, including single quantity sizes, from 8 oz. up to 48 oz. While these items are separate, they are often used together as would be the case when getting a drink during evening or nighttime hours. This feat often requires the balancing of a flashlight while pouring a drink, which often results in spills and messes. Additionally, both of these items require space and/or weight allowances which are often at a premium during camping activities.

Accordingly, there exists a need for a means by which the functions of a water or beverage container can be combined with that of a battery powered light to produce an item that not only combines the functions of the two but also produces a soothing viewing experience.

Of particular note, U.S. Pat. No. 6,286,719, issued in the name of the present applicant (Troy Haines) on Sep. 11, 2001, discloses an illuminated beverage container, the specification herein incorporated by reference as if rewritten in its entirety.

### SUMMARY OF THE INVENTION

It is therefore an object of the present invention to provide a beverage container with illumination means.

It is another object of the present invention to provide an illuminated beverage container for use in poorly illuminated areas, and especially at night on biking excursions or camping trips.

It is another object of the present invention to provide an illuminated beverage container fabricated from a durable material capable of withstanding repeated usage, and further fabricated from a material with insulating properties to reduce the transfer of heat or cold as desired.

It is another object of the present invention to provide an illuminated beverage container having an annular ring through which a beverage source (such as a plastic bottle) may be inserted therethrough.

It is another object of the present invention to provide an illuminated beverage container having a threaded cap with an adjustable spout for storage and dispensing of the liquid contained therein.

It is another object of the present invention to provide an illuminated beverage container with a rotatable dial for engaging or disengaging illumination means.

It is another object of the present invention to provide an illuminated beverage container with a plurality of ribs for enhancing a user's grip on the container.

Briefly described according to one embodiment of the present invention, an illuminated beverage container includes a top portion, a base portion and a body portion therebetween, the top, base and body portions combining to form a storage volume for holding desired liquid beverages. The base portion includes a rotatable dial for engaging and disengaging illumination means, wherein illumination means provides illumination through the beverage contained therein, through the beverage container, and/or through a lens provided in the base portion.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an embodiment of an illuminated beverage container, illustrating a single opening (to the left of the container) and an annular ring through which a beverage source may be place therethrough;

FIG. 2 is a perspective view of another embodiment of an illuminated beverage container, illustrating a dual opening (to the left and right of the container) and an annular ring through which a beverage source may be place therethrough;

FIG. 3 is a perspective view of another embodiment of an illuminated beverage container having a threaded cap with a spout for dispensing liquid;

FIG. 4 is a perspective view of an embodiment of a base portion with a rotatable dial for engaging and disengaging illumination means;

FIG. 5 is a side view of the base portion and rotatable dial;

FIG. 6 is a top view of a lens formed in the base portion;

FIG. 7 is a perspective view of another embodiment of the base portion and rotatable dial;

FIG. 8 is a side view of the base portion of FIG. 7; and

FIG. 9 is a top view of the battery compartment cover.

### DESCRIPTION OF THE PREFERRED EMBODIMENTS

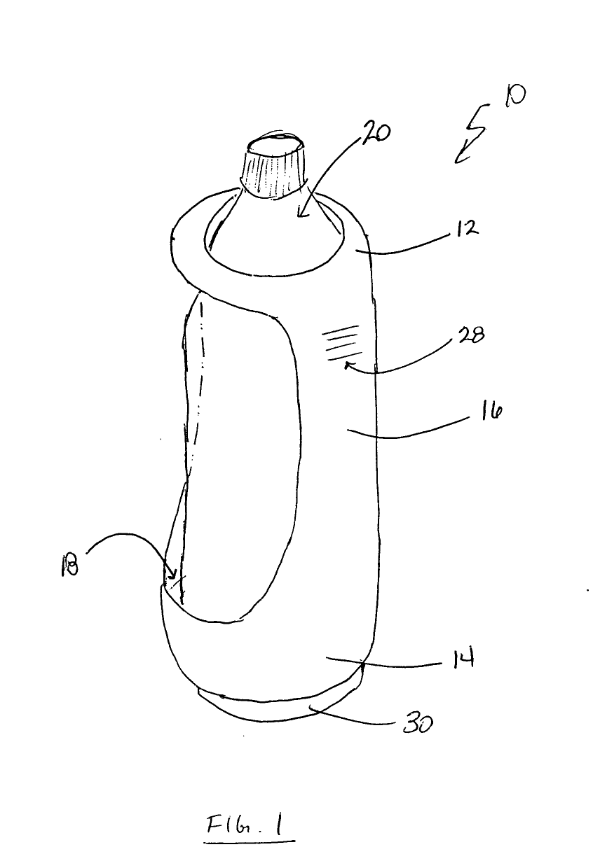

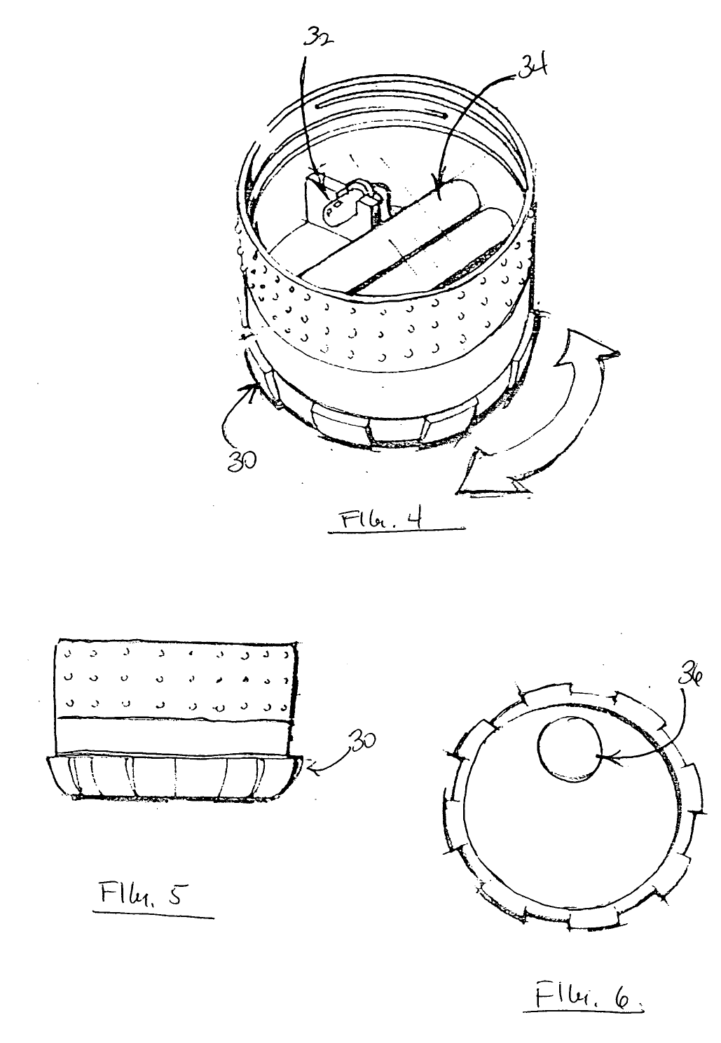

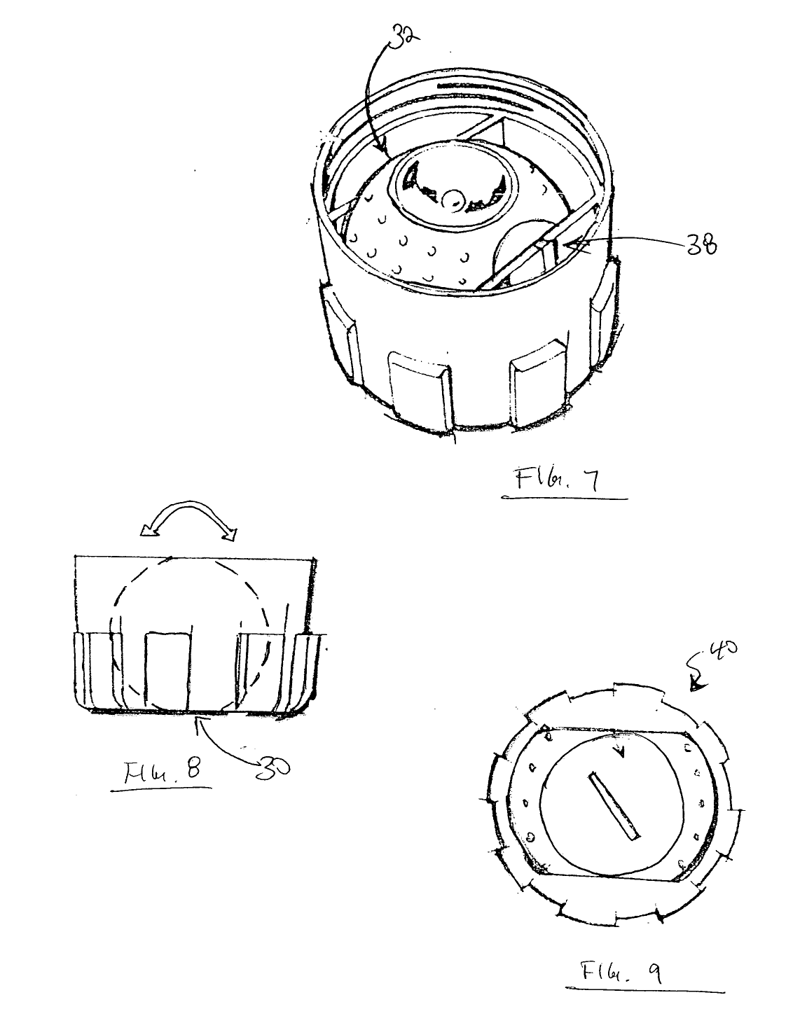

The best mode for carrying out the invention is presented in terms of its preferred embodiment, herein depicted within FIGS. 1 through 9.

1. Detailed Description of the Figures

Referring now to FIG. 1 through FIG. 3, an illuminated beverage container 10 is shown in accordance with a preferred embodiment of the present invention. The illuminated beverage container 10 comprises a top portion 12, a base portion 14 and a body portion 16 therebetween. The top, base and body portions 12, 14 and 16, respectively, form an internal volume 18 for storage and containment of a volume of liquid, wherein the volume of liquid is directly placed therein or is housed within a beverage source 20 (such as a plastic bottle) that is placed therein. The container 10 is envisioned as being manufactured from plastic or rubber, and preferably manufactured from NEOPRENE®. It is further envisioned that the container 10 is manufactured from a material having insulating properties to reduce the transfer of heat or cold from the beverage contained therein, thereby preserving the desired hotness or coldness of the user's beverage.

The top portion 12 is envisioned as having two general embodiments, illustrated by FIG. 1 and FIG. 3, respectively. In FIG. 1, the top portion 12 is shown as having an annular rim coextensive with a top opening 22. The opening 22 is provided to permit the insertion of a beverage source 20 therethrough, with the annular ring serving to reduce the lateral movement of the beverage source 20. In FIG. 3, the top portion 12 includes a threaded cap 24 with a vertically adjustable spout 26. The threaded cap 24 permits ingress and egress to the internal volume 18 and allows insertion and extraction of liquid beverages therein. The spout 26 operates to secure the liquid within the internal volume 18 or dispense the liquid to a user, depending upon the vertical orientation of the spout 26 (i.e., opened or closed spout).

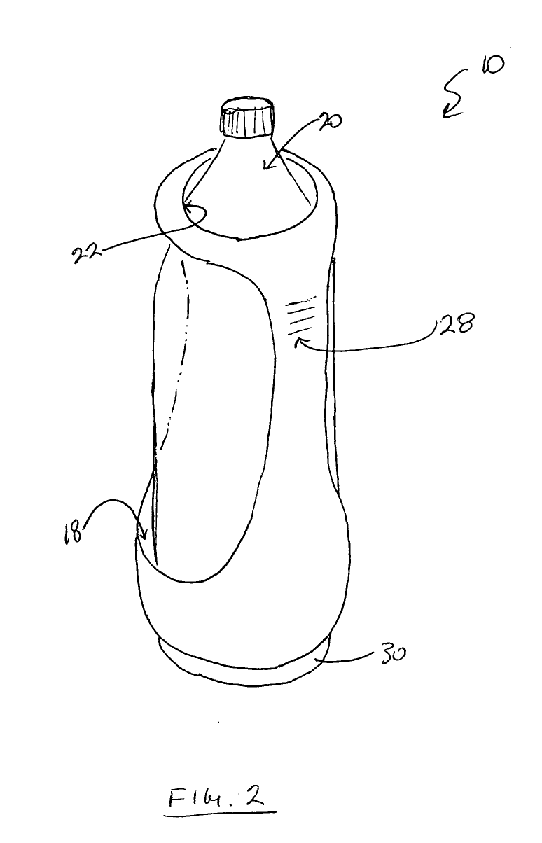

The body portion 16 is envisioned as having a variety of configurations, including a partially opened body portion as illustrated in FIG. 1 through FIG. 3, wherein the partial openings are embodied by a single opening (FIG. 1) or dual openings (FIG. 2 and FIG. 3). Other embodiments envisioned include a solid body portion completely circumscribing the internal volume 18. Along the exterior of the body portion 16, it is envisioned that a plurality of ribs 28 (or other gripping means) are provided to enhance the gripping capabilities of a user, and therefore reducing spills or drops. It is further envisioned that the openings formed in the body portion 16 may be covered by a transparent, translucent or opaque cover 50, either as integral to the container 10 or as a component that may be snap-fit (interference fit) over the openings as a decorative cover. It is envisioned that the cover(s) 50 used have insulating properties similar to the insulating properties desirable in the body portion 16 of container 10.

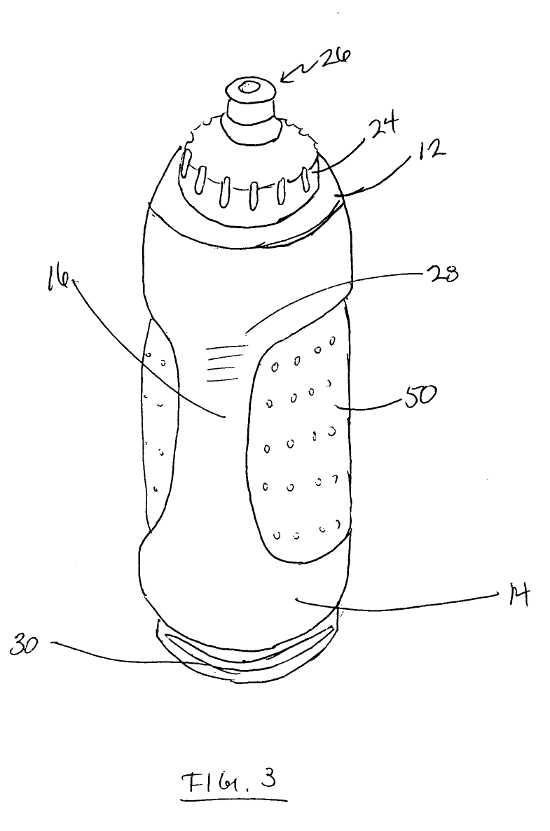

The base portion 14 terminates a lower end of the illuminated beverage container 10, providing support to the liquid directly housed therein or to the beverage source 20 placed therein. The base portion 14 further includes a rotatable dial 30 for actuating illumination of the light source 32 provided in the illuminated beverage container 10. The light source 32 is electrically coupled to a battery source 34, wherein the dial 30 is rotated to a proper engagement position, the battery source 34 provides energy to the light source 32, thereby provides illumination to the beverage container 10. Two embodiments of the base portion 14 with a rotatable dial 30 are illustrated, the first embodiment in FIG. 4 through FIG. 6, and the second embodiment in FIG. 7 through FIG. 9. In the second embodiment illustrated, a rotatable dial 30 engages and disengages a switch 38 that actuates energizing of light source 32. A battery compartment cover 40 is illustrated and provided to allow ease of removing and inserting batteries as required.

It is envisioned that the base portion 14 embodies at least three illumination configurations. The first configuration provides that the light source 32 is directed upward from the base portion 14 toward the beverage source 20 so that illumination of the liquid contained therein is visible, as well as illumination of any transparent, translucent or opaque cover 50 materials that adorn the body portion 16. A second configuration provides that the light source 32 is directed downward from the base portion 14 through a lens 36 provided in the base portion 14. The lens 36 may be of varying sizes and/or shapes, and may include adjustable coloring. The third configuration provides that the light source 32 is directed both upward and downward, wherein illumination is visible through the container 10 and through the lens 36.

2. Operation of the Preferred Embodiment

To use the present invention, one simply fills the beverage container with a beverage or installs a beverage container purchased pre-filled with a beverage. The device is then transported such as when camping and placed on any surface. An on/off switch on the front of the fluorescent light allows a light installed in a cavity in the base to be turned on or off as desired. The fluorescent/incandescent light shines up into the beverage container through a transparent lens lighting the beverage in the container. The fluorescent light can be removed from base to be used as an independent lighting source as desired. A special latch on the front of the fluorescent/incandescent light releases the fluorescent/incandescent light from the base. The fluorescent/incandescent light is powered by ordinary or rechargeable batteries.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

1. An illuminated beverage container comprising:
a beverage container comprises a top portion, a base portion and a body portion therebetween, said top, base and body portions, respectively, forming an internal volume for storage and containment of a volume of liquid; and
an illumination means incorporated into said base portion for providing a light source in the illuminated beverage container

2. The illuminated beverage container of claim 1, wherein said beverage container is formed of a material selected from the group comprising plastic, rubber, and glass.

3. The illuminated beverage container of claim 1, wherein said beverage container is formed of a material having insulating properties to reduce the transfer of heat or cold from the beverage contained therein, thereby preserving the desired hotness or coldness of the user's beverage.

4. The illuminated beverage container of claim 1, wherein said top portion forms an annular rim coextensive with a top opening, said top opening provided to permit the insertion of a beverage source therethrough and said annular ring serving to reduce the lateral movement of the beverage source.

5. The illuminated beverage container of claim 1, where said top portion comprises a threaded cap with a vertically adjustable spout, said threaded cap permitting ingress and egress to said internal volume and allows insertion and extraction of liquid beverages therein and said spout operates to secure the liquid within the internal volume or dispense the liquid to a user, depending upon the vertical orientation of the spout.

6. The illuminated beverage container of claim 1, wherein said body includes a partially opened body portion, and further comprises:
a cover covering siad open body portion formed of a transparent, translucent or opaque material.

7. The illuminated beverage container of claim 1, wherein said body comprises a solid body portion completely circumscribing said internal volume.

8. The illuminated beverage container of claim 1, further comprising a plurality of gripping means formed on an outer surface of said body portion to enhance the gripping capabilities of a user.

9. The illuminated beverage container of claim 1, wherein said base portion terminates a lower end of said illuminated beverage container for providing support to the liquid directly housed therein or to the beverage source placed therein.

10. The illuminated beverage container of claim 9, wherein said base portion further includes a rotatable dial for actuating illumination of said light source provided in the illuminated beverage container.

11. The illuminated beverage container of claim 10, wherein said light source is electrically coupled to a battery source, wherein when said dial is rotated to a proper engagement position, said battery source provides energy to the light source and thereby provides illumination to the beverage container.

12. The illuminated beverage container of claim 10, wherein said light source is electrically coupled to a battery source, wherein when a rotatable dial is rotated it engages and disengages a switch that actuates energizing of light source.

13. The illuminated beverage container of claim 11, wherein when said light source is directed upward from the base portion toward the beverage source so
